(19) United States
(12) Patent Application Publication
(10) Pub. No.: US 2008/0096609 A1
(43) Pub. Date: Apr. 24, 2008

(54) Temperature Sensing and Transmission Apparatus and Protocol for Mobile Phone

(76) Inventors: Cory Lam, Montebello, CA (US); Yubing Bai, Montebello, CA (US)

Correspondence Address: LAW OFFICES OF J.F. LEE, 17800 CASTLETON STREET, SUITE 383, CITY OF INDUSTRY, CA, 91748, US

(21) Appl. No.: 11/552,034

(22) Filed: Oct. 23, 2006

(51) Int. Cl. H04B 1/38; H04M 1/00

(52) U.S. Cl. 455/566

(57) ABSTRACT

A temperature sensing and transmission apparatus and protocol for mobile phones is introduced in present invention. Phone users can transmit and receive temperature information via the phone network's data channel, in addition to the voice and video data that are commonly seen today. The added dimension of temperature information facilitates the phone conversation and also helps to determine if weather could be a factor in situation where environmental considerations are vital, such as search and rescue mission when mobile phone users call out for help.

### FIELD AND BACKGROUND OF THE INVENTION

The present invention relates generally to a valued-added service and gadget that can be achieved by today's mobile phone industry, by incorporating temperature sensors into the mobile phones, and having the requisite data processing and transformation functional modules to send the temperature reading over the mobile phone network.

When people start a conversation over the phone, including mobile phones, asking about weather information on the other end is usually done verbally, with vague answers of “very cold”, “extremely hot”, etc. Unless a thermometer is used, not much meaningful temperature information is relayed over the telephone network, in the traditional way.

Present invention's temperature sensor and the functional modules provide the effective measurement of temperature reading and the transmission capability to let mobile phone users, both transmitting end and receiving end, know the temperature of the other end, enabling communication for one added dimension, in addition to voice and images (built-in camera).

Additionally, the use of a temperature duplicator enables the receiving end to feel (within a limited range) the environmental temperature as felt by the user on the transmitting end. Such micro heat coil or cooling pump for use on the duplicator is available on the market and is not part of the claimed invention, except to the extent the ways and manners for which such coil/pump is incorporated to the claimed elements of present invention.

Present invention also aides in the situation where phone users may be mired in some inclement weather, so that the transmission of temperature information pursuant to disclosure of present application will help the necessary search and rescue missions.

### OBJECTS AND SUMMARY OF THE INVENTION

A temperature sensor and duplicator is designed and built in as part of the mobile phone. This can be part of the phone housing like the way built-in camera is popularly done nowadays.

When a mobile phone conversation is set up, for transmission of voice or other forms of data, mobile user has the option of activating the temperature sensing and transmitting mechanism, where the temperature measurements are taken at a fixed interval and sent out via the phone data channel having connection to receiving end's mobile phone for display.

The presentation of temperature information can be done by specific applications, in the forms of degrees (Celsius or Fahrenheit), color coding by ranges, or other animation with or without sound effects on the display.

Present invention thus provides an added dimension of data transmission, increasing the value of mobile phone for its utility and for purpose of a conversation starter when whether is mentioned among phone users, or when the temperature information of the other party's environment is important for purpose of search and rescue and others.

### DESCRIPTION OF THE DRAWINGS

The accompanying drawings, which are incorporated in and constitute a part of this specification, illustrate the preferred embodiments of the invention and together with the description, serve to explain the principles of the invention. Changes and modifications to the described embodiments may be made in alternative arrangements without departing from the scope of the invention as set forth herein.

A brief description of the drawings is as follows:

FIG. 1 shows a temperature sensor unit built to the front bottom of a mobile phone. A temperature duplicator is also shown alongside the sensor.

FIG. 2 shows a temperature sensor unit built to the back of a mobile phone. A temperature duplicator is also shown alongside the sensor.

FIG. 3 shows a temperature sensor probe that can be pulled out from the mobile phone.

FIG. 4 shows the block diagram for temperature data transmission of present invention.

FIG. 5 shows the sample call setup sequence contemplated in present invention.

### DETAILED DESCRIPTION OF THE PREFERRED EMBODIMENT

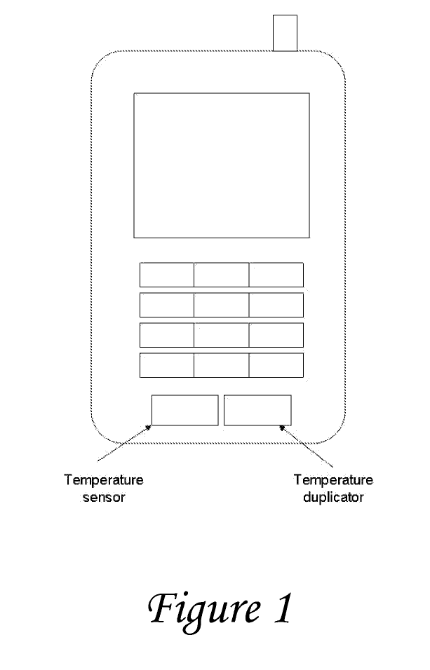

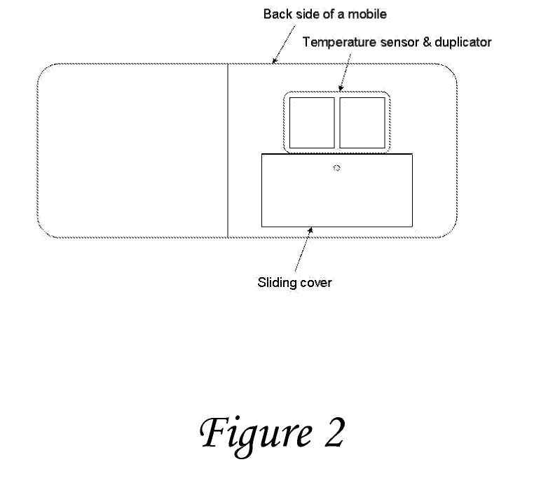

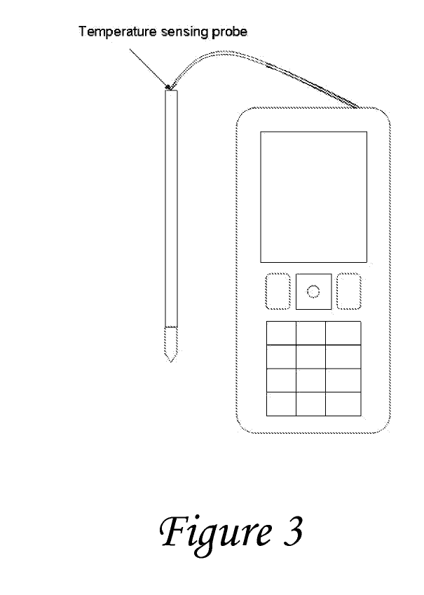

FIGS. 1-3 show the places where typical temperature sensors and duplicators can be located.

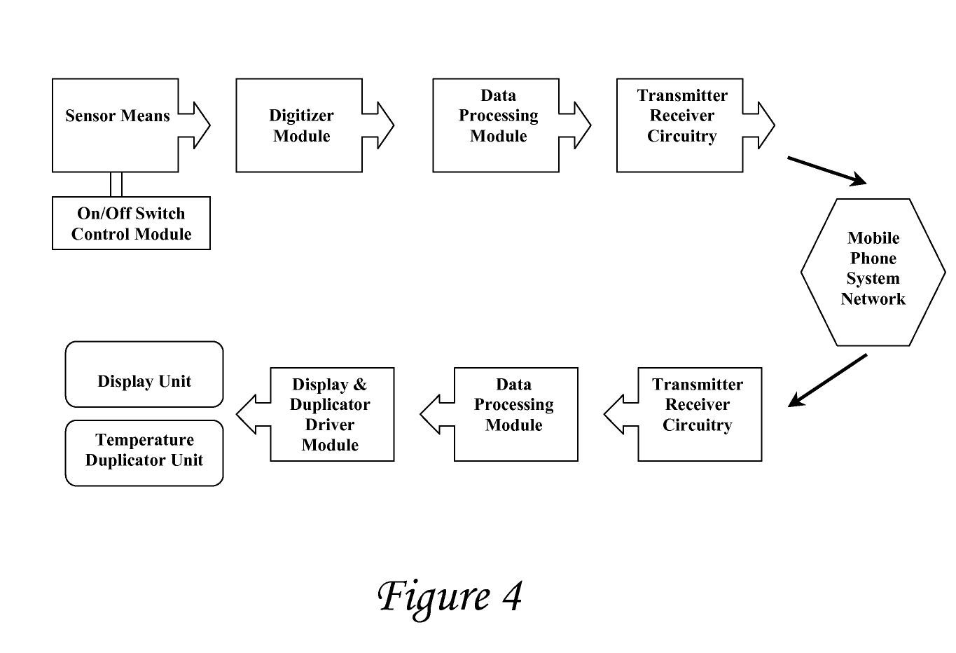

FIG. 4 shows the module diagram to carry out the temperature sensing and transmission as intended in present invention.

Temperature reading is first obtained via a temperature sensing means, located in places on a mobile phone, as shown in FIGS. 1-3, and other places.

A digitizer mechanism module then transforms the temperature reading from the sensor and send to data processing module, which turns the digitized data into phone data channel format, mostly in Internet Protocol (IP) format.

The transmitter and receiver circuitry module then sends the processed data over the phone network. On the receiving end, the same circuitry receives the information via the call session's data channel and sends it onward to the data processing module.

A display/duplicator driver module on the receiving end then convert the received temperature information into desired format, such as numbers, color coded ranges, or other animated display, and send forward to the display. This module further utilizes a built-in micro cooling pump and/or a micro heat coil, depending on the current temperature and the received temperature information from the phone network, to generate the desired temperature, within a limited range not to exceed the capability of the micro cooling pump or the heat coil currently available on the market.

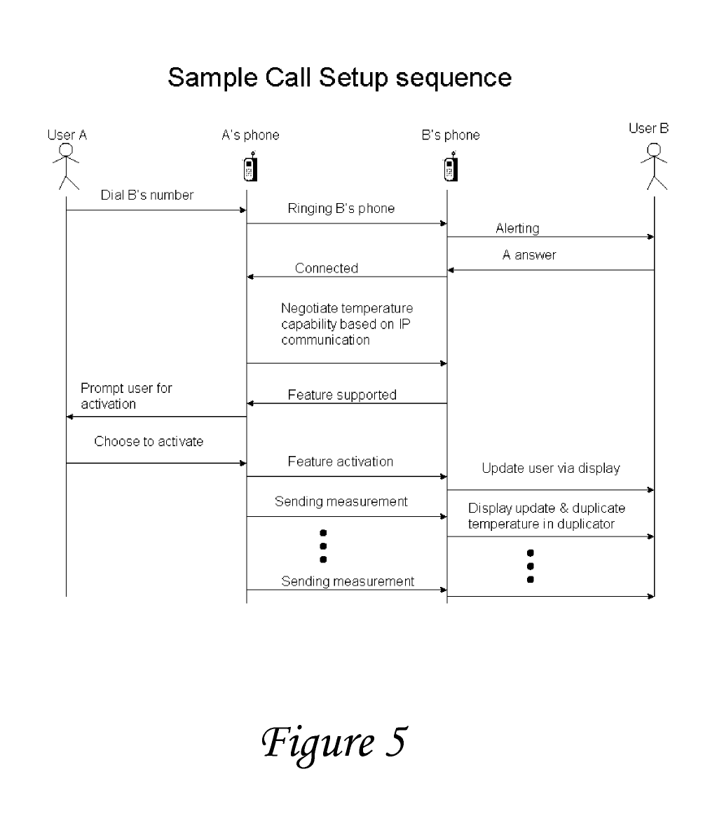

FIG. 5 shows the call setup sequence of two mobile phone users, when present temperature sensing and transmitting apparatus and protocol are in use. The temperature measurement will be sampled based on pre-configured sampling rate to obtain the temperature reading, if the hardware is in a state of enabled measurement, using the built-in sensor, or using a sensor probe when it is pulled out.

If the mobile phone network is based on IP Multimedia Subsystem as specified by 3GPP, the data can be encapsulated as XML data and sent via a SIP signaling protocol.

Once the temperature reading is received, it can be displayed as actual numbers on the receiver's phone. Alternatively, some color-coded ranges, or some form of animation to represent the temperature ranges can be done to display the temperature information onto the display part of the mobile phone.

Additionally, a control module to implement an automatic “on/off” switch function can be added to the mobile phone with the temperature sensor as disclosed in present invention, so that temperature sensing and data transmission can be made automatic whenever a call session is established. The “on/off” switch module can also be activated externally by emergency search crew, making this feature most useful in time of inclement weather and search and rescue scenario.

What is claimed is:

1. Temperature sensing and transmission apparatus and protocol for mobile phone, comprising:
a. Mobile phones and the transmission network;
b. Temperature sensing means attached to mobile phone units;
c. Digitizer mechanism on the mobile phone for transforming data obtained from temperature sensing means;
d. Data processing module on the mobile phone,
e. Transmitter and Receiver circuitry module on the mobile phone, and;
f. Temperature display/duplicator driver module on the mobile phone for converting received temperature information and for displaying onto LCD panel on mobile phones and for sending driver signals to built-in micro heat coil or micro cooling pump,

2. The apparatus and protocol as defined in claim 1 wherein data processing module is to perform the function of transforming digitized temperature reading into IP protocol used on mobile phone network and the function of transforming temperature information in IP protocol into a decoded format for feeding to said duplicator module.

3. The apparatus and protocol as defined in claim 2 further having a temperature duplicator module for generating the temperature on the receiving end, reflecting the temperature information as sensed in the transmitting end.

4. The apparatus and protocol as defined in claim 3 wherein said temperature sensing means is a temperature sensor located at lower end of mobile phone front panel.

5. The apparatus and protocol as defined in claim 3 wherein said temperature sensing means is a temperature sensor located at the back side of a mobile phone.

6. The apparatus and protocol as defined in claim 3 wherein said temperature sensing means is a probe attached to the mobile phone that can be pulled out and stored back in a slot for said probe.

7. The apparatus and protocol as defined in claim 3 further having an on/off switch module to activate the temperature sensing and transmission function during a call session, wherein said on/off switch can be set to be activated automatically when calls are initiated, or can be set to be activated by emergency handling crew.
